(19) United States
(12) Patent Application Publication
(10) Pub. No.: US 2010/0165165 A1
(43) Pub. Date: Jul. 1, 2010

(54) METHOD AND DEVICE FOR A CMOS IMAGE SENSOR

(75) Inventors: WENZHE LUO, Shanghai (CN); PAUL OUYANG, Shanghai (CN); JIM YANG, Shanghai (CN); HONG ZHU, Shanghai (CN)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Semiconductor Manufacturing International (Shanghai) Corporation, Shanghai (CN)

(21) Appl. No.: 12/582,694

(22) Filed: Oct. 20, 2009

(30) Foreign Application Priority Data
Dec. 31, 2008 (CN) 200810205380.7

(51) Int. Cl. H04N 5/335

(52) U.S. Cl. 348/308; 348/E05.091

(57) ABSTRACT

A method for determining photocurrents corresponding to a plurality of wavelength ranges. The method includes receiving at least a light by a photodiode within a first wavelength range. The first wavelength range includes a second wavelength range and a third wavelength range. The method provides a first bias voltage to the photodiode and determines a first photocurrent within the first wavelength range, the first photocurrent being associated with the photodiode and the first bias voltage. The method also provides a second bias voltage to the photodiode, different from the first bias voltage, and determines a second photocurrent within the first wavelength range, the second photocurrent being associated with the photodiode and the second bias voltage. The method further includes processing information associated with the first and second photocurrents, and determining at least a third photocurrent corresponding to the second wavelength range and a fourth photocurrent corresponding to the third wavelength range.

### CROSS-REFERENCES TO RELATED APPLICATIONS

This application claims priority to Chinese Patent Application No. 200810205380.7 filed Dec. 31, 2008, commonly assigned, incorporated by reference herein for all purposes.

### BACKGROUND OF THE INVENTION

The present invention is directed to integrated circuits and their processing for the manufacture of semiconductor devices. More particularly, embodiments of the invention provide a method and device for manufacturing and operating an image sensing apparatus including a CMOS photodiode. The CMOS photodiode can be configured to differentiate multiple colors in response to multiple bias conditions. But it would be recognized that the invention has a much broader range of applicability. For example, the invention can be applied to other imaging devices, memory devices, integrated circuits, and others. In another example, the invention can be implemented in image sensing arrays built in silicon or other semiconductor substrates.

FIG. 1 is an illustration of a conventional photodiode APS (Active Pixel Sensor) 100. Photodiode APS 100 includes a photodiode D1 (140) and three NMOS transistors, denoted as M1 (110), M2 (120), and M3 (130), respectively. Photodiode D1 (140) converts incident photons 150 to electronic charges. When photons strike the photodiode, electron-hole pairs are generated. Minority carriers (such as holes in N-regions or electrons in the P-regions) can either be recombined, or be collected as photocurrent with an electric field in the PN junction. The magnitude of the photocurrent is related to the intensity of the light. The photocurrent is discharged through node X and determines the ramp-down rate of the voltage V_{X} at node X. The photo current read out is described below.

As shown in FIG. 1, transistor M1 (110) is used for reset of the pixel cell 100 for the initiation of cell readout operations. When reset signal RST is high, node X of photodiode D1 (140) is pre-charged to V_{DD}-V_{TN}, where V_{DD} a voltage supply and V_{TN} is a threshold voltage of transistor M1 (110). In FIG. 1, M1 is an NMOS transistor. Transistor M2 (120) is used as a source-follower amplifier so that the voltage signal from the photodiode V_{X} is amplified and easier for readout. Transistor M3 (130) is a row-select gate that allows pixel cells in the same column to be multiplexed to the column bus for detection and further processing.

Traditionally, an array of photodiode APS cells forms a black/white imager without color sensing capacity. In order for the imager to sense color, a color filter coating is typically added on top of the array, forming a so-called Color Filter Array (CFA). Each CFA cell covers the light sensing part of each color image sensor (CIS) cell, letting only one primary color (i.e., red, green, or blue) through and reject all other colors. Therefore, each individual CIS cell senses only one color. Through interpolation of adjacent pixel colors, all color components are found for each pixel and a color image of every pixel is thus constructed.

In some conventional techniques, after the semiconductor process of manufacturing CIS array, a back-end process of color coating is applied to finish the color image sensor array manufacturing. The disadvantages of this scheme are twofold: (i) The back-end process adds significant cost, and (ii) Each cell only senses one color component, the other color components have to be attained through interpolation, which introduces un-intended filtering and inaccuracy.

In an attempt to overcome the disadvantages of the traditional CIS array with CFA structure, an image sensor array is made based on a stacked photodiode structure. In this approach, the cell structure uses layers of N-WELL and P-EPI to form three different photodiodes at different depths from the silicon surface and uses thru-hole to connect the terminals of the diodes.

In conventional techniques, for example a Foveon sensor, the image sensor cell separates different color based on the principle that lights of different wavelengths have different penetration depths in silicon. Blue light (wavelength 400-490 nm) penetrates to a depth of 0.2-0.5 microns in silicon, green light (wavelength 490-575 nm) penetrates to a depth of 0.5-1.5 microns, and red light (wavelength 575-700 nm) penetrates to a depth of 1.5-3.0 microns. Therefore, three diodes, which are formed at different depths of a silicon material corresponding to the different color absorption ranges, will have different absorption ratios of blue, green and red colors. The three diodes respond preferentially to blue, green and red lights, respectively, and generate photocurrents, which are read out by their respective buffers. The disadvantage of the Foveon sensor is that it adds process complexity and increase manufacture cost. In addition, since the photodiodes are positioned in different depths of silicon material, thru-holes have to be made to connect the discharge nodes of the read out circuits.

From the above, it is seen that an improved technique for color sensing in an image array is desired.

### BRIEF SUMMARY OF THE INVENTION

According to embodiments of the present invention, techniques for the manufacture of semiconductor devices are provided. More particularly, the invention provides a method and a device for manufacturing and operating an image sensing apparatus including a CMOS photodiode. The CMOS photodiode is configured to differentiate multiple colors in response to multiple bias conditions. But it would be recognized that the invention has a much broader range of applicability. For example, the invention can be applied to other imaging devices, memory devices, integrated circuits, and others. Additionally, the invention can be implemented in image sensing arrays built in silicon or other semiconductor substrates.

In a specific embodiment, the invention provides a method for determining photocurrents corresponding to a plurality of wavelength ranges. The method includes, in part, receiving at least a light by a photodiode within a first wavelength range, the first wavelength range including a second wavelength range and a third wavelength range. The method also includes, in part, providing a first bias voltage to the photodiode and determining a first photocurrent within the first wavelength range, the first photocurrent being associated with the photodiode and the first bias voltage. The method also includes, in part, providing a second bias voltage to the photodiode, the second bias voltage being different from the first bias voltage and determining a second photocurrent within the first wavelength range, the second photocurrent being associated with the photodiode and the second bias voltage. The method further includes, in part, processing information associated with the first photocurrent and the second photocurrent, and determining at least a third photocurrent corresponding to the second wavelength range and a fourth photocurrent corresponding to the third wavelength range based on information associated with the first photocurrent and the second photocurrent. In an embodiment, the method includes determining absorption coefficients of second wavelength range and third wavelength range at each bias voltage. In a specific embodiment, the method also includes determining quantum efficiency of second wavelength range and third wavelength at each bias voltage.

In an alternative specific embodiment, the invention provides a color sensing apparatus formed in a semiconductor substrate associated with a first conductivity type. The color sensing apparatus is configured to be capable of detecting light corresponding to at least a first wavelength range and a second wavelength range, the first wavelength range corresponding to a first absorption depth, the second wavelength range corresponding to a second absorption depth. The color sensing apparatus includes, in part, a first region associated with a second conductivity type in the semiconductor substrate, the first region forming a junction within the semiconductor substrate at a junction depth, the junction depth being substantially equal to the first light absorption depth. The color sensing apparatus also includes, in part, a voltage supply configured to provide at least a first bias voltage and a second bias voltage between the first region and the semiconductor substrate such that a depletion region of the junction extends to a depletion depth equal to or larger than the first light absorption depth and the second absorption depth respectively. The color sensing apparatus further includes, in part, a current sensing device configured to measure a first photocurrent and a second photocurrent corresponding to the first bias voltage and the second bias voltage, respectively.

In yet another embodiment, the invention provides a color sensing apparatus formed in a semiconductor substrate associated with a first conductivity type. The color sensing apparatus is configured to be capable of detecting light corresponding to at least a first wavelength range and a second wavelength range, the first wavelength range corresponding to a first absorption depth, the second wavelength range corresponding to a second absorption depth. The color sensing apparatus includes, in part, a first region associated with a second conductivity type formed in the semiconductor substrate and a second region associated with the first conductivity type formed in the first region, the second region forming a junction within the first region at a junction depth, the junction depth being substantially equal to the first light absorption depth. The color sensing apparatus also includes, in part, an isolation region associated with the first conductivity type formed in the first region, the isolation region being configured to surround the junction and to extend through the depth of the first region. The color sensing apparatus further includes, in part, a voltage supply configured to provide at least a first bias voltage and a second bias voltage between the second region and the first region such that a depletion region of the junction extends to a depletion depth equal to or larger than the first light absorption depth and the second absorption depth respectively. The color sensing apparatus also includes, in part, a current sensing device configured to measure a first photocurrent and a second photocurrent corresponding to the first bias voltage and the second bias voltage, respectively.

Many benefits are achieved by way of the present invention over conventional techniques. For example, certain embodiments of the present invention reduce color aliasing artifacts by ensuring that all pixels in an imaging array measure blue, green, and red response in the same place in the pixel structure. Color filtration takes place by applying different bias voltages to the sensor junction for different colors. By eliminating color filters often used in conventional devices, cost saving and higher quantum efficiency can be achieved. Some embodiments of the present invention offer other benefits. For instance, the present technique provides an easy to use process that relies upon conventional technology without substantial modifications to conventional equipment and processes. In some embodiments, the method provides reduced complexity and higher device yields in dies per wafer. Some embodiments of the present invention can be implemented in an image sensing array with highly integrated devices such as CMOS logic and memory devices. Depending upon the embodiment, one or more of these benefits may be achieved. These and other benefits will be described in more throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIG. 1 is an illustration of a conventional photodiode color sensor.

FIG. 2 is a simplified schematic diagram illustrating an image sensing apparatus according to an embodiment of the present invention.

FIG. 3a is a simplified illustration of cross sectional view of a photodiode according to an embodiment of the present invention.

FIG. 3b is a simplified illustration of cross sectional view of a photodiode according to an alternative embodiment of the present invention.

FIG. 4 is simplified illustration of a method for operating an image sensing apparatus according to an embodiment of the present invention.

FIG. 5 is a simplified illustration of cross sectional views of a photodiode under different bias conditions according to an embodiment of the present invention.

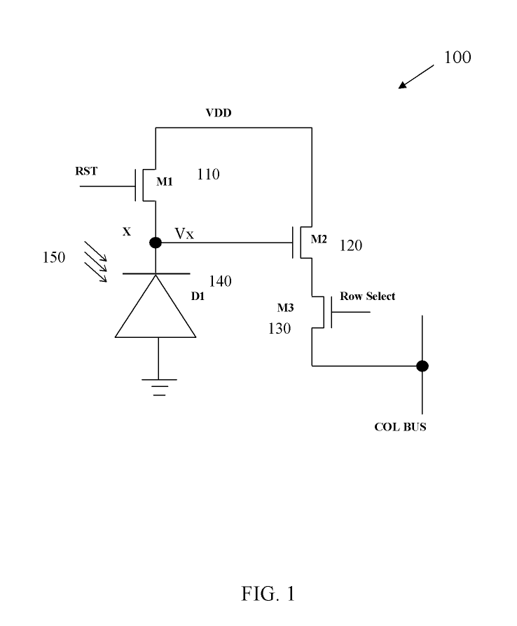

### DETAILED DESCRIPTION OF THE INVENTION

According to embodiments of the present invention, techniques for the manufacture of semiconductor devices are provided. More particularly, the invention provides a method and device for manufacturing and operating an image sensing apparatus including a CMOS photodiode. The photodiode can be configured to differentiate multiple colors in response to multiple bias conditions. But it would be recognized that the invention has a much broader range of applicability. For example, the invention can be applied to other imaging devices, memory devices, integrated circuits, and other devices. The invention can also be implemented in image sensing arrays built in silicon or other semiconductor substrates.

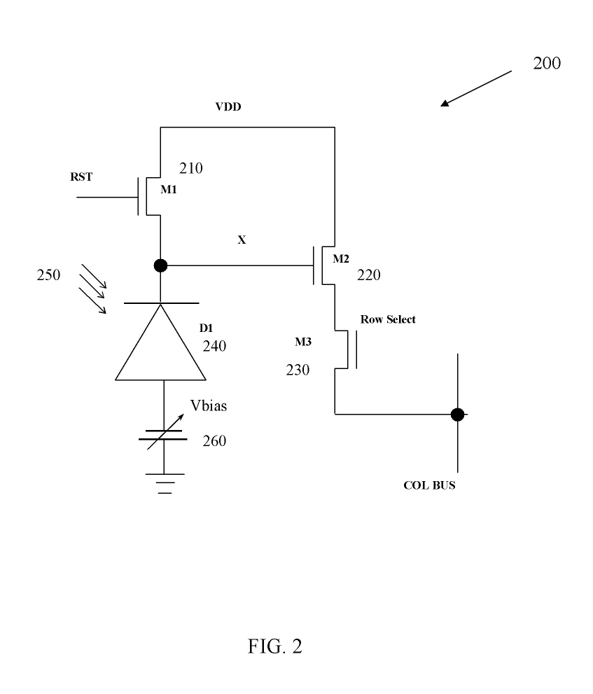

FIG. 2 is a simplified schematic diagram illustrating an image sensing apparatus according to an embodiment of the present invention. This diagram is merely an example, which should not unduly limit the scope of the claims herein. One of ordinary skill in the art would recognize other variations, modifications, and alternatives. As shown, photodiode APS (active pixel sensor) 200 includes, in part, a photodiode D1 (240). A P-type terminal of photodiode D1 (240) is coupled to a variable voltage source 260, and an N-type terminal of photodiode D1 (240) is coupled to a terminal of transistor M1 (210) at node X. When reset signal RST is high and, in the absence of light, photodiode D1 (240) is reverse biased, with the voltage Vx at node X pre-charged to V_{DD}-V_{TN}, where V_{DD} is a voltage supply and V_{TN} is a threshold voltage of transistor M1 (210). When exposed to light 250, photodiode D1 (240) converts incident photons to electronic charges. When photons are absorbed in a junction region of photodiode D1 (240), electron-hole pairs are generated. Minority carriers (such as holes in N-regions or electrons in the P-regions) can be collected as photocurrent with an electric field in the PN junction. The magnitude of the photocurrent reflects the intensity of the light.

As discussed earlier, photons from lights of different colors (e. g., red, green, and blue) are absorbed in different depths of the silicon substrate. According to an embodiment of this invention as shown in FIG. 2, a variable voltage source 260 is provided for controlling a reverse bias voltage V_{bias} on photodiode D1 (240), so that the depletion region depth of the photodiode N-P junction can be varied. When the depletion region is narrow, the photodiode collects mostly blue light. When the depletion region becomes wider, the photodiode collects green light. When the depletion region becomes even wider, the photodiode collects red light. Therefore, by applying different back biases to the photodiode, different photo charges corresponding to different combinations of wavelength components of the incoming light are collected. As will be discussed subsequently, by detail calibration of the wavelength to photocurrent measurement results, the intensity of light corresponding to different colors can be calculated.

Referring back to FIG. 2, an N-type terminal of photodiode D1 (240) is connected to node X. The photocurrent generated in photodiode D1 (240) is discharged through node X, and a voltage at the node X, V_{X}, is pulled down in response to the photocurrent. Node X is coupled to a gate terminal of transistor M2 (220), which is used as a source-follower amplifier so that the voltage signal from the photodiode V_{X} is amplified for readout. Transistor M3 (230) is a row-select gate that allows pixels in the same column of the image cell array to be multiplexed to a column bus for detection and further processing.

As shown in FIG. 2, NMOS transistor M1 (210) is used for reset of the pixel cell for the initiation of cell readout operations, and a high reset signal RST is used to pre-charge node X. Alternatively M1 (210) can be changed to a PMOS transistor, in which case a reset signal RST active at a low voltage will be used.

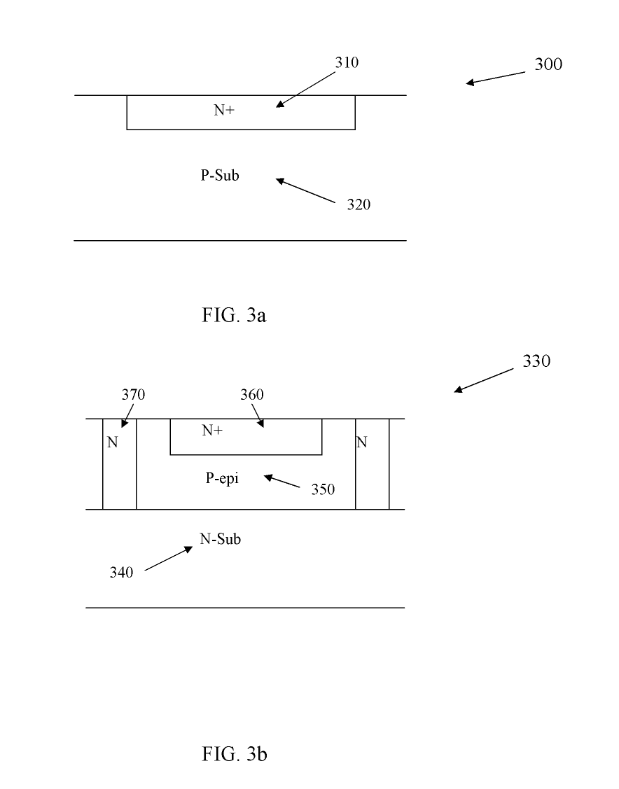

There can be many variations in process implementation of the image sensor cell as shown in FIG. 2. As shown in FIG. 3a, a simplified illustration of a cross sectional view of a photodiode 300 according to an embodiment of the present invention is provided. This diagram is merely an example, which should not unduly limit the scope of the claims herein. One of ordinary skill in the art would recognize other variations, modifications, and alternatives. As shown, photodiode 300 includes an N-type region 310 in a P-type silicon substrate 320. An N-P junction is formed at the interface between N-type region 310 in a P-type silicon substrate 320. This embodiment is compatible with a typical P-substrate, N-well CMOS process. If logic circuit is integrated on the same chip, the P-substrate of the logic circuit can be isolated with a deep-N-well method.

FIG. 3b is a simplified diagram illustrating a photodiode 330 according to an alternative embodiment of the present invention. This diagram is merely an example, which should not unduly limit the scope of the claims herein. One of ordinary skill in the art would recognize other variations, modifications, and alternatives. In this example, an N-substrate 340 is used or, alternatively, a thick N-type epitaxial layer on a P-substrate can be used. A P-epi layer 350 is grown on N-substrate 340. A junction between an N+ diffusion 360 region in the P-epi layer 350 form the light sensitive area of photodiode 330. N-type isolation regions 370 and 380 are formed to surround each of the pixel cells for isolation purposes. The N+ region 360, P-epi layer 350 , and the N-substrate 340 can all be individually biased to improve photo charge collection efficiency. This embodiment of photodiode 330 is more reliable in terms of cross talk and photoelectron collection efficiency.

The techniques provided by embodiments of the invention bring significant advantages to the process and design of image sensing cells. For example, only one photodiode and only one read out circuit are needed for each pixel cell which provides signals for all three primary colors. In addition, no color filters are needed. Therefore, smaller chip area, reduced process and circuit complexity, and lower cost are achieved.

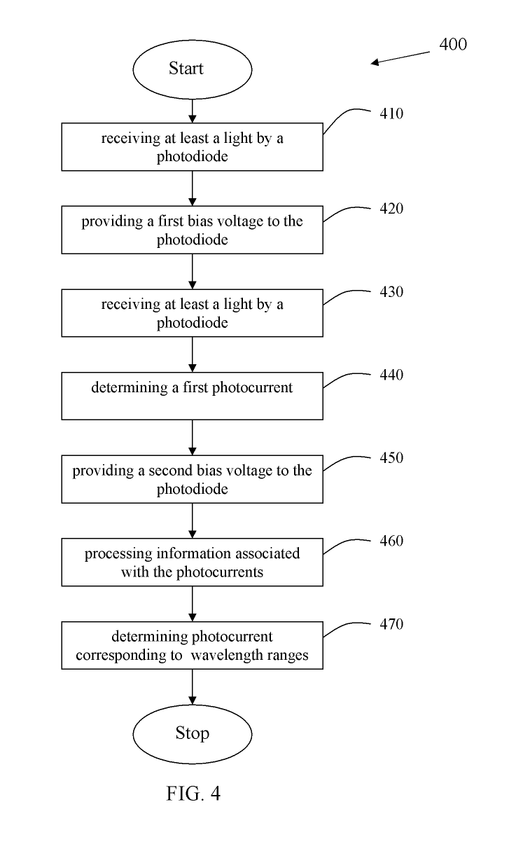

FIG. 4 is simplified flowchart of a method for operating an image sensing apparatus according to an embodiment of the present invention. This diagram is merely an example, which should not unduly limit the scope of the claims herein. One of ordinary skill in the art would recognize other variations, modifications, and alternatives. As shown in FIG. 4, the method includes, in step 410, receiving at least a light by a photodiode within a first wavelength range. The first wavelength range includes a second wavelength range and a third wavelength range. In step 420, the method provides a first bias voltage to the photodiode, and in step 430, the method determines a first photocurrent within the first wavelength range, the first photocurrent being associated with the photodiode and the first bias voltage. In step 440 the method provides a second bias voltage to the photodiode, the second bias voltage being different from the first bias voltage. The method includes step 450 which determines a second photocurrent within the first wavelength range, the second photocurrent being associated with the photodiode and the second bias voltage. In step 460, the method processes information associated with the first photocurrent and the second photocurrent, and then in step 470 the method determines at least a third photocurrent corresponding to the second wavelength range and a fourth photocurrent corresponding to the third wavelength range based on information associated with the first photocurrent and the second photocurrent.

The method also includes, not shown in FIG. 4, determining absorption of second wavelength range and third wavelength range at each bias voltage, and determining quantum efficiency of second wavelength range and third wavelength at each bias voltage. Some of the details will be further discussed in the paragraphs that follow.

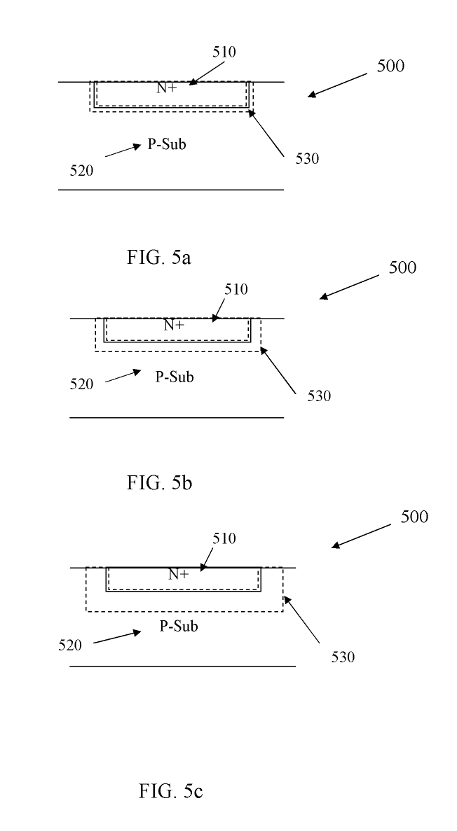

FIG. 5 is a simplified illustration of cross sectional views of a photodiode 500 under different bias conditions according to an embodiment of the present invention. This diagram is merely an example, which should not unduly limit the scope of the claims herein. One of ordinary skill in the art would recognize other variations, modifications, and alternatives. In FIG. 5a, N-type region 510 and P-type region 520 form an N-P junction 530 in photodiode 500. The dashed lines show the boundaries of the N-P junction depletion region, which varies under different reverse bias voltage. In FIG. 5(a), a small bias (for example, 0 V, not shown in FIG. 5) is applied to photodiode 500. The depletion region 530 across the N-P junction is narrow (for example <0.3 um). Under this condition, blue light will be mostly collected, green light will be collected slightly, and red light will be barely collected by photodiode 500. In FIG. 5(b), a medium bias (for example 2V, not shown) is applied to photodiode 500, causing depletion region 540 across the N-P junction to be wider (for example about 1 um) than that in FIG. 5(a). Under this condition of medium bias, blue light will be mostly collected by the photodiode, green will be collected more than in FIG. 5(a), and a small portion of red light will be collected by the photodiode. In FIG. 5(c), a large bias (for example 8 V, not shown) is applied to photodiode 500, and the depletion region 550 across the N-P junction is even wider (for example˜3 um). In the case of large bias, blue light will be mostly collected, more green light will be collected than in FIG. 5(b), and a significant portion of red light will also be collected by the photodiode.

Under different bias conditions, different combinations of blue, green, and red light are collected by the photodiode. Merely for illustration purposes, let us assume that the incoming light corresponding to different colors is collected according to the percentages shown below.

(a) 90%*IB+10%*IG+2%*IR;

(b) 95%*IB+40%*IG+10%*IR;

(c) 98%*IB+60%*IG+30%*IR;

IB, IG, and IR denote the light intensity of the different colors, representative of the number of photons striking on the photodiode area per second. The amount of photocurrent generated within the photodiode depends not only on collection efficiency of the color of the light, but also on spectrum efficiency, which is related to a ratio of the electric power output to the light power input. For example, if we designate the spectrum efficiency of blue, green, and red lights corresponding to three bias conditions shown in FIGS. 5(a), 5(b), and 5(c), respectively, as r11, r12, r13, r21, r22, r23, r31, r32, and r33, then the generated photocurrents can be calculated as following:

(a) I(a)=90%*r11*IB+10%*r12*IG+2%*r13*IR;

(b) I(b)=95%*r21*IB+40%*r22*IG+10%*r23*IR;

(c) I(c)=98%*r31*IB+60%*r32*IG+30%*r33*IR;

In the above equations, I(a), I(b), and I(c) designate the photocurrents generated under the first, second, and third bias conditions, respectively, The spectrum efficiency (the rij values in the above equations) can be characterized through detailed experiments. Then, by measuring I(a), I(b), and I(c) through the readout circuits and ADC (analog-to-digital converter), not shown in FIG. 2, the intensity of different colors IB, IG, and IR can be obtained.

In the above discussion, three bias voltages are used. In other embodiments of the invention, more than three biasing voltages can be applied for the measurements. Alternatively, fewer than three bias voltages can be used to sense lights in different ranges of wavelengths. Photon collection efficiency can be improved, for example, by doping profiles design or N-P junction engineering, or by using hetero-junctions.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method for determining photocurrents corresponding to a plurality of wavelength ranges, the method comprising:
receiving at least a light by a photodiode within a first wavelength range, the first wavelength range including a second wavelength range and a third wavelength range;
providing a first bias voltage to the photodiode;
determining a first photocurrent within the first wavelength range, the first photocurrent being associated with the photodiode and the first bias voltage;
providing a second bias voltage to the photodiode, the second bias voltage being different from the first bias voltage;
determining a second photocurrent within the first wavelength range, the second photocurrent being associated with the photodiode and the second bias voltage;
processing information associated with the first photocurrent and the second photocurrent; and
determining at least a third photocurrent corresponding to the second wavelength range and a fourth photocurrent corresponding to the third wavelength range based on information associated with the first photocurrent and the second photocurrent.

2. The method of claim 1, wherein the second wavelength range overlaps the third wavelength range.

3. The method of claim 1, wherein the second wavelength range and the third wavelength range are non-overlapping.

4. The method of claim 1, wherein the first wavelength range further includes a fourth wavelength range.

5. The method of claim 4, further comprising:
providing a third bias voltage to the photodiode, the third bias voltage being different from the first and second bias voltages.

6. The method of claim 5, wherein the second, third, and fourth wavelength ranges are associated substantially with blue, green, and red lights, respectively.

7. The method of claim 6, wherein the first bias voltage is about 0 volts, the second bias voltage is about 2 volts, and the third bias voltage is about 8 volts.

8. The method of claim 1, further comprising:
determining absorption coefficients of second wavelength range and third wavelength range at each bias voltage;

9. The method of claim 8, further comprising:
determining quantum efficiency of second wavelength range and third wavelength at each bias voltage.

10. A color sensing apparatus formed in a semiconductor substrate associated with a first conductivity type, the color sensing apparatus capable of detecting light corresponding to at least a first wavelength range and a second wavelength range, the first wavelength range corresponding to a first absorption depth, the second wavelength range corresponding to a second absorption depth, the color sensing apparatus comprising:
a first region associated with a second conductivity type in the semiconductor substrate, the first region forming a junction within the semiconductor substrate at a junction depth, the junction depth being substantially equal to the first light absorption depth;
a voltage supply configured to provide at least a first bias voltage and a second bias voltage between the first region and the semiconductor substrate such that a depletion region of the junction extends to a depletion depth equal to or larger than the first light absorption depth and the second absorption depth respectively; and
a current sensing device configured to measure a first photocurrent and a second photocurrent corresponding to the first bias voltage and the second bias voltage, respectively.

11. The color sensing apparatus of claim 10, wherein the semiconductor substrate is a silicon substrate.

12. The color sensing apparatus of claim 10, wherein the first conductivity type is P-type and the second conductivity type is N-type.

13. The color sensing apparatus of claim 10, wherein the second wavelength range overlaps the third wavelength range.

14. The color sensing apparatus of claim 10, wherein the second wavelength range and the third wavelength range are non-overlapping.

15. The color sensing apparatus of claim 10, wherein the voltage supply is further configured to provide a third bias voltage between the first region and the semiconductor substrate such that a depletion region of the junction extends to a depletion depth equal to or larger than a third light absorption depth, the third light absorption depth being larger than the first light absorption depth and the second absorption depth, respectively.

16. The color sensing apparatus of claim 15, wherein the first, second, and third light absorption depths are associated substantially with blue, green, and red light, respectively.

17. The color sensing apparatus of claim 15, wherein the current sensing device is further configured to measure a third photocurrent corresponding to the third bias voltage.

18. A color sensing apparatus as recited in claim 15, wherein a depletion region of the junction extends to a depth of about 0.2-0.5 microns, about 0.5-1.5 microns, and about 1.5-3.0 microns, in response to the first, second, and third bias voltages, respectively.

19. A color sensing apparatus as recited in claim 15, wherein the first bias voltage is about 0 volts, the second bias voltage is about 2 volts, and the third bias voltage is about 8 volts.

20. A color sensing apparatus formed in a semiconductor substrate associated with a first conductivity type, the color sensing apparatus capable of detecting light corresponding to at least a first wavelength range and a second wavelength range, the first wavelength range corresponding to a first absorption depth, the second wavelength range corresponding to a second absorption depth, the color sensing apparatus comprising:
a first region associated with a second conductivity type formed in the semiconductor substrate;
a second region associated with the first conductivity type formed in the first region, the second region forming a junction within the first region at a junction depth, the junction depth being substantially equal to the first light absorption depth;
an isolation region associated with the first conductivity type formed in the first region, the isolation region being configured to surround the junction and to extend through the depth of the first region;
a voltage supply configured to provide at least a first bias voltage and a second bias voltage between the second region and the first region such that a depletion region of the junction extends to a depletion depth equal to or larger than the first light absorption depth and the second absorption depth respectively; and
a current sensing device configured to measure a first photocurrent and a second photocurrent corresponding to the first bias voltage and the second bias voltage, respectively.

21. The color sensing apparatus of claim 20, wherein the first conductivity type is N-type and the second conductivity type is P-type.
